(19) United States
(12) Patent Application Publication
(10) Pub. No.: US 2016/0177789 A1
(43) Pub. Date: Jun. 23, 2016

(54) TURBOSHAFT ENGINE EXHAUST NOZZLE HAVING ITS OUTLET PERPENDICULAR TO THE AXIS OF ROTATION OF THE ENGINE

(71) Applicant: AIRBUS HELICOPTERS, Marignane (FR)

(72) Inventors: Olivier HONNORAT, Aix En Provence (FR); Jan KRYSINSKI, Lodz (PL); Krzysztof SOBCZAK, Lodz (PL)

(21) Appl. No.: 14/963,370

(22) Filed: Dec. 9, 2015

(30) Foreign Application Priority Data
Dec. 22, 2014 (FR) 14 02953

(51) Int. Cl. F01D 25/30; F02K 1/06

(52) U.S. Cl. CPC F01D 25/30; F02K 1/06

(57) ABSTRACT

A gas exhaust nozzle for a gas turbine, the exhaust nozzle having an annular inlet section centered on the axis of the gas turbine, a diffuser, a plenum chamber, and an expansion nozzle. The diffuser extends around the axis with a shape that diverges from the inlet section to the plenum chamber, and comprises an inner first surface and an outer first surface that are concave on the same side. The plenum chamber extends around the axis and is defined firstly by the diffuser and secondly by an outer second surface extending the inner first surface and joining the outer first surface. The plenum chamber includes a radial opening leading into the expansion nozzle, the exhaust gas leaving the expansion nozzle perpendicularly to the axis.

### CROSS REFERENCE TO RELATED APPLICATION

This application claims priority to French patent application No. FR 14 02953 filed on Dec. 22, 2014, the disclosure of which is incorporated in its entirety by reference herein.

### BACKGROUND OF THE INVENTION

(1) Field of the Invention

The present invention relates to the field of gas turbines, and more particularly gas turbines for rotary wing aircraft.

The present invention relates to an exhaust nozzle for a gas turbine and to a power plant having at least one gas turbine and at least one such exhaust nozzle.

(2) Description of Related Art

Rotary wing aircraft are generally provided with one or more turboshaft engines that act via at least one main rotor to provide the aircraft with lift and possibly also propulsion. For an application to a rotary wing aircraft, a turboshaft engine is a gas turbine that generally comprises a free turbine driving rotation of at least one main rotor of the aircraft. The operation of the engine must therefore optimize the power delivered by the free turbine, in particular by limiting energy losses in the exhaust gas, in particular downstream from the free turbine.

Exhaust gas is ejected from the free turbine at high speed and at a pressure higher than atmospheric pressure, and it then flows along an exhaust nozzle until it is discharged into the atmosphere. A particular function of the exhaust nozzle is to direct the exhaust gas towards an outlet and to expand the exhaust gas in order to bring it to atmospheric pressure.

In order to achieve this expansion, an exhaust nozzle progressively reduces the speed of the exhaust gas. Nevertheless, such expansion leads to the exhaust gas suffering head losses in the exhaust nozzle, in particular as a result of the turbulence generated in the exhaust gas and as a result of friction between the exhaust gas and the wall of the nozzle. Such head loses then lead to losses of energy from the power plant formed by the turboshaft engine and the exhaust nozzle, and consequently to a drop in the performance of the engine.

It is commonly accepted that a change of 1% in head losses in the exhaust nozzle leads to an identical change of 1% in the power from the turboshaft engine and to an identical change of 1% in the specific fuel consumption of the engine. Furthermore, the operation of the engine can also be impacted by such high head losses in the exhaust nozzle, e.g. by reducing its surge margin.

Reducing the head losses that can be generated in the exhaust gas by an exhaust nozzle is thus fundamental to optimizing the performance of a turboshaft engine. When the engine forms part of a rotary wing aircraft, these head losses that give rise to a loss of power from the engine are harmful to the operation of the aircraft in general and more particularly during certain particular stages of flight, such as takeoff, landing, and hovering.

In general, an exhaust nozzle is installed in line with the turboshaft engine, along its axis of rotation, with the nozzle then being said to be “simple” in shape. By way of example, the exhaust nozzle comprises an expansion nozzle of diverging shape such as a truncated cone having a straight generator line, with its section increasing progressively so as to reduce the flow speed of the exhaust gas, in compliance with a relationship for conserving mass flow rate. That type of “simple” exhaust nozzle is the most effective in limiting head losses, with such head losses generally being about 1%.

Furthermore, an exhaust nozzle may also include an outlet nozzle serving to direct the exhaust gas at the outlet from the exhaust nozzle in a direction that is slightly inclined relative to the axis of rotation of the turboshaft engine. This outlet nozzle, referred to as a “secondary” nozzle, is then installed at the end of the expansion nozzle, which is then referred to as the “primary” nozzle, in which the exhaust gas is previously slowed down. This applies for example to a rotary wing aircraft having two turboshaft engines, with the exhaust nozzle from each of the engines then including a respective secondary nozzle with a bend in order to discharge the exhaust gas from the sides of the aircraft. Such a secondary nozzle with a bend often has the effect of doubling head losses compared with a “simple” exhaust nozzle. With certain twin-engined aircraft, the secondary nozzle with a bend may for example form an angle of as much as eighty degrees (80°) or ninety degrees (90°) relative to the primary nozzle, i.e. in such a manner that the exhaust gas exits in a direction that is substantially perpendicular to the axis of the engine.

In addition, certain turboshaft engine installations on an aircraft require the exhaust nozzle to perform a tight bend in order to “escape” from an obstacle, such as a firewall, an engine cover, or indeed an installation constraint. Such a tight bend may involve a right angle bend for discharging gas from the side of the aircraft. In addition, such a tight bend can be situated relatively close to the outlet from the free turbine of the turboshaft engine so that the dimensions of the expansion nozzle are then small. The speed of the exhaust gas then cannot be reduced sufficiently by the expansion nozzle prior to reaching the tight bend, thereby generating relatively large head losses.

Furthermore, a gas turbine may be fitted with a secondary nozzle that is movable in order to direct the exhaust gas. In particular, vertical takeoff and landing (VTOL) aircraft and vertical and/or short takeoff and landing (VSTOL) aircraft may use jet engines including such movable outlet nozzles. Such movable outlet nozzles enable the exhaust gas to be directed and consequently enable thrust from the engines to be directed, both along the axis of each engine or else along an axis that is inclined relative to the axis of each engine, at an angle of inclination that may be as much as 90°.

By way of example, an exhaust gas deflection system for a gas turbine as described in Document FR 2 010 251 has two segments that are movable in rotation in order to direct the exhaust gas stream perpendicularly to the axis of the turbine, along a circular path.

Document EP 0 118 181 describes a device for deflecting the flow path of exhaust gas from a jet engine. That deflection device has movable portions capable of forming a first flow path that is curved, with guide vanes being positioned in the middle of that curved first flow path. When the movable portions form a second flow path along the axis of the engine, the guide vanes become positioned along that second flow path.

Also known is Document EP 1 104 847, which describes an outlet nozzle from a gas turbine that has a primary nozzle and a secondary nozzle that are substantially coaxial, the primary nozzle being situated inside the secondary nozzle and projecting axially from the secondary nozzle. The outlet sections of the primary and secondary nozzles are inclined relative to a direction perpendicular to their common axis, thus making it possible in particular to reduce the noise generated by the gas turbine.

Finally, Document EP 2 357 323 describes an exhaust gas diffuser for a gas turbine. That diffuser has an annular inlet and two exhaust pipes enabling exhaust gas to be discharged. Four radial openings allow the exhaust gas to flow from the annular inlet to the two pipes. The four radial openings cover the entire periphery of the annular inlet.

In all of those configurations, an essential concern is keeping head losses under control and finding the best possible shape for the exhaust nozzle in order to avoid degrading the performance of engines. Furthermore, head losses in a fluid are proportional mainly to the square of the speed of the fluid. As a result, since exhaust gas leaves the free turbine of a turboshaft engine at high speed, it is important to reduce this speed quickly so as to limit such head losses.

### BRIEF SUMMARY OF THE INVENTION

An object of the present invention is thus to provide an exhaust nozzle for a gas turbine that enables the exhaust gas from the gas turbine to be directed while avoiding the above-mentioned limitations, and in particular while reducing the flow speed of the exhaust gas leaving the gas turbine and while limiting the head losses of the exhaust gas prior to leaving the exhaust nozzle.

According to the invention, an exhaust nozzle comprises in succession in the flow direction of a gas through the exhaust nozzle:
an annular inlet section centered on a first axis, a first direction F1 being defined parallel to the first axis and extending in the flow direction of the gas;
a diffuser;
a plenum chamber; and
a single expansion nozzle having a first end connected to the plenum chamber and having a second end with an expansion section, a first diverging shape of the expansion nozzle going from the plenum chamber to the expansion section, a second direction F2 being defined parallel to a mean exit direction of the gas from the expansion nozzle and extending in the flow direction of the gas.

This exhaust nozzle is intended in particular for a gas turbine, the gas passing through the exhaust nozzle being the exhaust gas from the gas turbine. The exhaust gas leaves the gas turbine and then enters into the exhaust nozzle via the annular inlet section, after which it flows through the exhaust nozzle.

The first axis of the annular inlet section coincides with the axis of rotation of the gas turbine.

Because of the diverging shape of the expansion nozzle, when the gas passes through the expansion nozzle its pressure decreases until the gas leaves the expansion nozzle via its expansion section. This first diverging shape of the expansion nozzle has a flow section of area that increases progressively from the plenum chamber to the expansion section.

The term “flow section” is used to mean the inside area of this first diverging shape that extends perpendicularly to a mean flow direction of a gas through the first diverging shape. The mean gas flow direction in an arbitrary shape is defined for laminar flow of the gas through the shape and it is the mean of the gas flow directions.

This first diverging shape may for example be a truncated cone having a generator line that is straight or indeed curvilinear, the mean flow direction of the gas then being along the axis of the truncated cone.

Furthermore, the second direction F2 is defined parallel to the mean outlet direction of the gas from the expansion nozzle, which corresponds to this mean gas flow direction at the expansion section. This second direction F2 is directed in the gas flow direction.

This exhaust nozzle is remarkable in that the diffuser extends around the first axis with a second diverging shape going from the inlet section to the plenum chamber. The diffuser comprises an inner first surface and an outer first surface, the gas flowing between the inner and outer first surfaces and leaving the diffuser via an outlet section of the diffuser into the plenum chamber.

Furthermore, the plenum chamber is defined firstly by the diffuser and secondly by an outer second surface extending the inner first surface of the diffuser and joining the outer first surface of the diffuser, the plenum chamber having the single radial opening leading into the expansion nozzle.

Finally, the expansion nozzle is arranged so that the second direction F2 forms a first angle α lying in the range 60° to 180° with the first direction F1.

The exhaust nozzle of the invention makes it possible to diffuse gas entering via the annular inlet section and to eject it from the side, the axial volume of the exhaust nozzle being small. The difficulty faced by this exhaust nozzle is then that of limiting the head losses to which the gas is subjected on passing through it, e.g. in order to avoid degrading the performance of the gas turbine that is connected to the exhaust nozzle and having its exhaust gas discharged via the exhaust nozzle.

Furthermore, the exhaust nozzle and the gas turbine to which it is connected may form a power plant of an aircraft, and more particularly of a rotary wing aircraft.

The diffuser that receives the incoming gas via the annular section thus comprises two first surfaces comprising an inner surface and an outer surface between which the gas flows from the annular inlet section to the plenum chamber. These inner and outer first surfaces are curvilinear and constitute respective shapes that are substantially conical about the first axis. Furthermore, the inner and outer first surfaces become spaced further apart from the first axis on going away from the annular inlet section. Finally, the inner and outer first surfaces constitute a second diverging shape in which the area of the flow section of the gas increases progressively from the annular inlet section to the plenum chamber.

This increase in the area of the flow section is progressive, radial, and small so as to ensure that the flow is as quiet as possible, while nevertheless reducing the flow speed of the gas.

Furthermore, in order to avoid points of separation occurring between the boundary layer of the gas and the inner and outer first surfaces, the inner first surface and the outer first surface vary continuously in the gas flow direction, i.e. the first derivatives of the inner and outer first surfaces are continuous.

Likewise, in order to avoid the appearance of such points of separation of the boundary layer of the gas, the inner and outer first surfaces do not include any line of inflection, i.e. for the inner first surface and for the outer first surface, the respective centers of curvature remain on the same side of the inner first surface or of the outer first surface all along those inner and outer first surfaces.

Furthermore, in order to ensure that the area of the flow section increases progressively, and consequently that the reduction in the flow speed of the gas in the diffuser is progressive, the inner first surface and the outer first surface are concave on the same side. The term “concave on the same side” is used to mean that the inner and outer first surfaces present curvatures directed in the same direction, i.e. the respective centers of curvature of the inner and outer first surfaces are situated on the same side of these inner and outer first surfaces.

The flow of gas through the diffuser can thus be laminar in part in the second diverging shape. This gas then suffers low head losses, while nevertheless having its flow speed reduced as it passes through the diffuser. In addition, depending on the shapes of the inner and outer first surfaces, it is possible for there to be no separation of the boundary layer of the gas from the inner first surface or from the outer first surface. At the very least, this separation of the boundary layer of the gas from the inner first surface and the outer first surface is delayed and lies in the terminal portion of the diffuser, i.e. close to the outlet section.

Thus, the second diverging shape of the diffuser of the exhaust nozzle of the invention varies in application of a relationship that makes it possible firstly to reduce progressively the speed of the gas flowing through the diffuser, and secondly to delay separation of the boundary layer of the gas from the inner first surface and from the outer first surface. Thus, the head losses suffered by the gas flowing through the diffuser are reduced.

After the diffuser, the gas flows into the plenum chamber, which serves to direct the gas leaving the diffuser towards the expansion nozzle to which the plenum chamber is connected. The absence of any sudden variation in the surfaces between which the gas flows is important for minimizing the head losses generated on passing from the diffuser to the plenum chamber.

For this purpose, the outer second surface of this plenum chamber extends the inner first surface of the diffuser in continuous manner. Likewise, this outer second surface of the plenum chamber joins the outer first surface of the diffuser in continuous manner. Thus, there is continuity in the complete surface formed by the inner first surface, the outer second surface, and the outer first surface. Furthermore, this complete surface varies in a manner that is continuous, i.e. the derivative of this complete surface is continuous.

Furthermore, as for the inner and outer first surfaces, the outer second surface does not contain any line of inflection, for the most part. Nevertheless, this outer second surface could include a line of inflection at the junction with the outer first surface of the diffuser. This line of inflection then has low effect or indeed no effect on the flow of gas that is going towards the radial opening of the plenum chamber.

The diffuser thus forms a curved volume directing the gas towards the plenum chamber, while reducing the speed of the gas and limiting the head losses generated by the diffuser. This curved volume is terminated by the outlet section that serves to define a third direction F3 perpendicular to the outlet section and directed in the flow direction of the gas.

This third direction F3 then forms a second angle β lying in the range 100° to 200° relative to the first direction F1.

By way of example, this second angle β may be equal to 180°. The diffuser thus enables the gas to form an about turn prior to entering the plenum chamber.

Furthermore, the plenum chamber extends around a second axis, the second axis intersecting the first axis.

Preferably, the second axis coincides with the first axis of the annular inlet section of the diffuser. Nevertheless, the second axis may form a non-zero third angle δ, e.g. lying in the range 0° to 15°, with the first axis.

Finally, the expansion nozzle is arranged so that the first angle α lies in the range 60° to 180°.

In addition, when the first angle α between the first direction F1 and the second direction F2 is equal to 90°, and when the first and second axes coincide, the diffuser and the plenum chamber have the shapes of respective bodies of revolution about the first axis.

Otherwise, the inner and outer first surfaces of the diffuser and the outer second surface are adapted so as to provide continuity at the radial opening between the inner and outer first surfaces of the diffuser, the outer second surface of the plenum chamber, and the third surfaces forming the corresponding expansion nozzle.

In addition, the exhaust nozzle has a plane of symmetry containing the first axis and the mean exit direction of the gas leaving the expansion nozzle. The second axis also lies in this plane of symmetry.

The plenum chamber may be defined by a height, measured parallel to the second axis, and a maximum diameter measured perpendicularly to the second axis. This height is the maximum distance between two points of the complete surface parallel to the second axis, whereas the maximum diameter is the maximum distance between two points of this complete surface perpendicularly to the second axis. The height is strictly less than the maximum diameter, and indeed much less than the maximum diameter, so as to provide a plenum chamber that is compact along the first axis.

For example, the height of the plenum chamber is equal to half its maximum diameter in order to obtain a good compromise between a compact exhaust nozzle and slowing down the flow speed of the gas, while minimizing the generation of head losses.

The plenum chamber then provides an inside volume that is sufficient for enabling the gas to flow from the diffuser to the radial opening, even though the plenum chamber is compact along the first axis. Furthermore, since the gas is slowed down greatly in the diffuser, the head losses suffered by the gas while it is flowing through the plenum chamber are reduced, since head losses are mainly proportional to the square of the flow speed of a gas.

By way of example, when a gas turbine is connected to the exhaust nozzle of the invention, the exhaust gas enters the diffuser of the exhaust nozzle at a speed of about 300 meters per second (m/s) and it leaves the diffuser at a speed of about 150 m/s.

Nevertheless, the plenum chamber could also include two radial openings, which are then preferably diametrically opposite, with the exhaust nozzle then having two expansion nozzles.

In addition, the flow of gas between the diffuser and the plenum chamber may generate considerable forces on the outer first surface, which has an end that is free inside the plenum chamber. Furthermore, at the outlet section, and more particularly at the outer first surface, sudden separation may occur in the gas flow, thereby generating turbulence in the gas flow. This turbulence not only has a negative effect on the head losses of the gas, but, for example, it can also generate vibration and/or give rise to cracks in the outer first surface. Furthermore, non-steady vortices may appear, e.g. in the proximity of this end of the outer first surface, thereby mechanically stressing this outer first surface.

Furthermore, vibration can also be transmitted to the exhaust nozzle by the gas turbine, or indeed by the aircraft fitted with the exhaust nozzle. The outer first surface, which is unsupported inside the plenum chamber, can then be relatively sensitive to such vibration and can be weakened thereby.

Advantageously, the outer first surface may then be terminated by a dropped edge at its outlet section. This dropped edge enables the stiffness of this outer first surface to be increased, firstly for the purpose of withstanding the forces generated on said outer first surface by the gas, and secondly in order to withstand vibration as induced in particular by the gas turbine or indeed by the aircraft fitted with the exhaust nozzle.

Furthermore, the presence of a dropped edge also makes it possible to avoid sudden separation in the gas flow and makes it possible for a stable and uniform vortex to appear at the end of the dropped edge. In addition to these mechanical properties, the dropped edge thus also makes it possible to avoid a zone of turbulence appearing at the outlet from the diffuser and to avoid unstable vortices appearing that generate turbulence and head losses in the gas.

Furthermore, the exhaust nozzle may include at least one heat exchanger and at least one outlet nozzle, each heat exchanger being positioned between the expansion nozzle and an outlet nozzle. This heat exchanger can thus use the heat of the gas flowing through the exhaust nozzle, e.g. in order to heat admission air prior to directing it into the combustion chamber of a gas turbine connected to the exhaust nozzle. The outlet nozzle then enables the gas leaving the heat exchanger to be directed into the atmosphere. This outlet nozzle may include a bend so as to change the flow direction of the gas. Since it is greatly slowed down by passing through the exhaust nozzle and the heat exchanger, this gas is then subjected to very low additional head losses, and possibly no additional head loss.

The exhaust nozzle of the invention thus makes it possible to diffuse gas at the outlet from a gas turbine, e.g. in a manner that is very progressive and radially uniform, the gas being brought into the plenum chamber and then ejected via the expansion nozzle.

The present invention also provides a power plant including at least one gas turbine and at least one exhaust nozzle as described above. Each gas turbine is connected to an exhaust nozzle via an annular inlet section of the exhaust nozzle. The exhaust gas from each gas turbine thus flows through an exhaust nozzle until it is ejected from the power plant.

### BRIEF DESCRIPTION OF THE SEVERAL VIEWS OF THE DRAWINGS

The invention and its advantages appear in greater detail from the context of the following description of embodiments given by way of illustration and with reference to the accompanying figures, in which:

FIG. 1 is a plan view of an exhaust nozzle of the invention;

FIG. 2 is a section view of a first embodiment of an exhaust nozzle; and

FIGS. 3 and 4 are an isometric view and a section view of a second embodiment of an exhaust nozzle.

Elements present in more than one of the figures are given the same references in each of them.

### DETAILED DESCRIPTION OF THE INVENTION

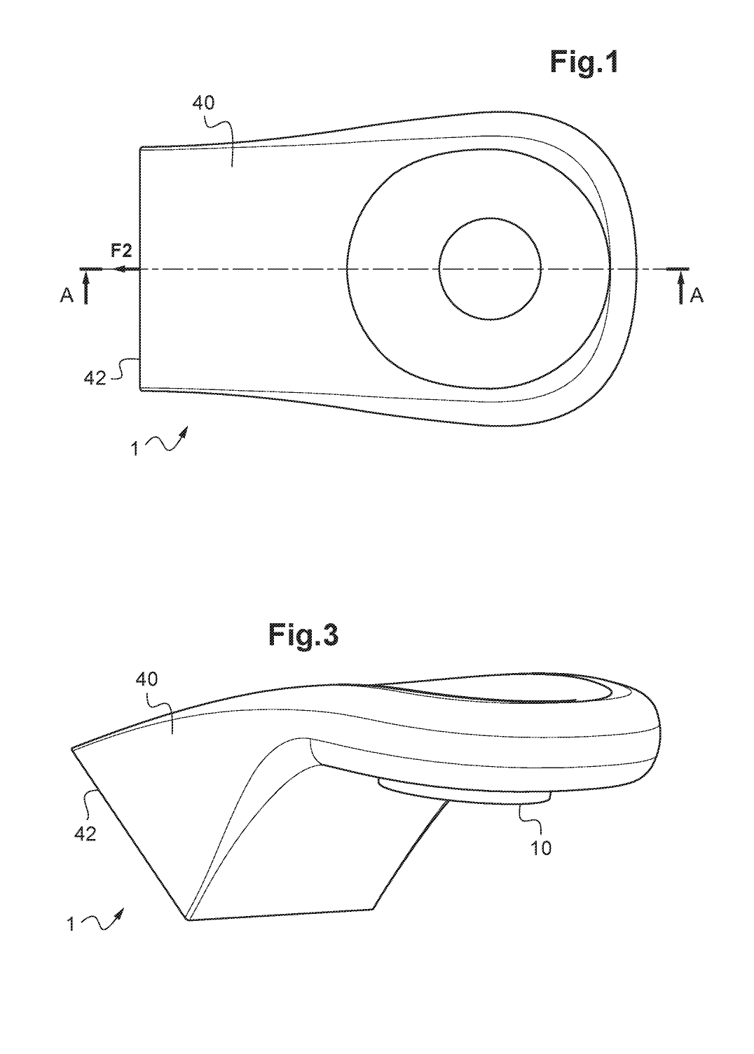

In FIG. 1, an exhaust nozzle 1 is shown in plan view, the exhaust nozzle 1 having a plane of symmetry AA.

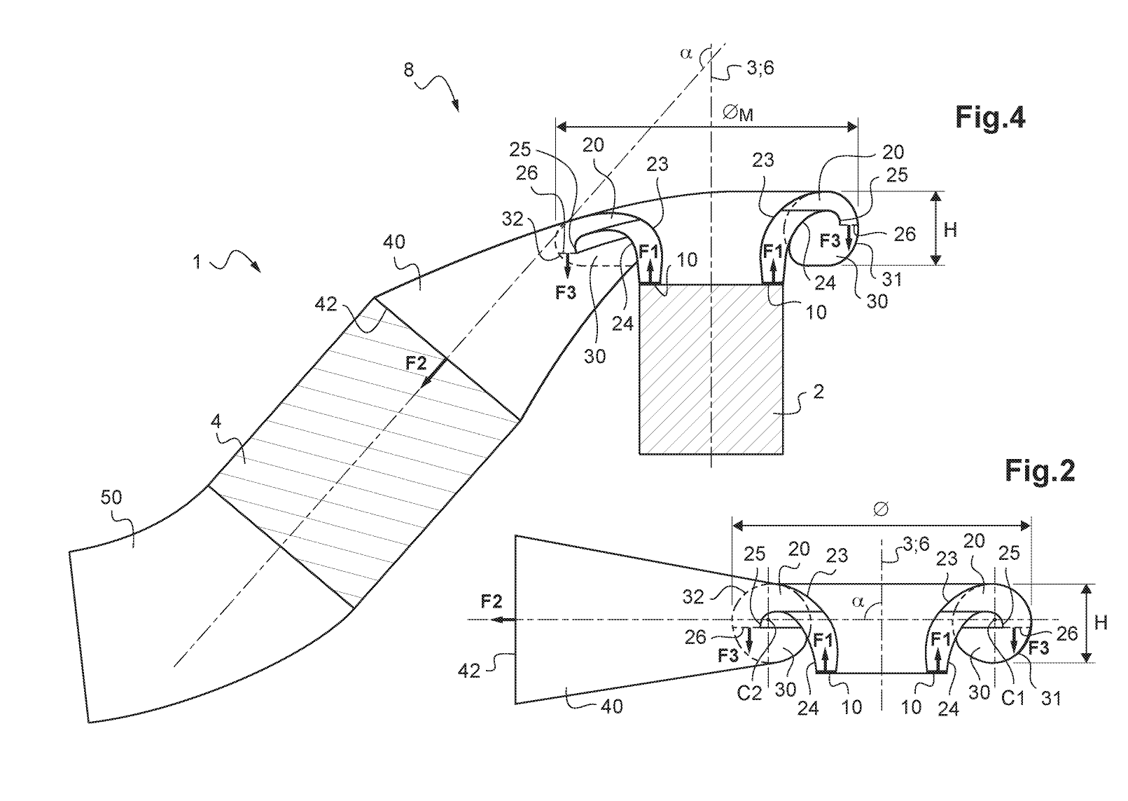

A first embodiment of an exhaust nozzle 1 is shown in FIG. 2 in section view on the plane of symmetry AA.

A second embodiment of an exhaust nozzle 1 is shown in FIGS. 3 and 4, respectively in an isometric view and in a section view on the plane of symmetry AA. In this second embodiment, the exhaust nozzle 1 has a heat exchanger 4 and an outlet nozzle 50, and together with a gas turbine 2 it forms a power plant 8. The heat exchanger 4, the outlet nozzle 50, and the gas turbine 2 can be seen in FIG. 4.

In manner that is common to both embodiments, the exhaust nozzle 1 has an annular inlet section 10, a diffuser 20, a plenum chamber 30, and an expansion nozzle 40. A gas can enter the exhaust nozzle 1 via the annular inlet section 10, after which it flows successively into the diffuser 20, the plenum chamber 30, and into the expansion nozzle 40.

The annular inlet section 10 is centered on a first axis lying in the plane of symmetry AA. A first direction F1 is defined parallel to the first axis 3 going towards the inside of the exhaust nozzle 1. This first direction F1 is thus directed in the direction of gas flow and entry into the exhaust nozzle 1.

The diffuser 20 extends around the first axis 3 and includes an inner first surface 23 and an outer first surface 24, together with an outlet section 26 at the junction between the diffuser 20 and the plenum chamber 30.

The plenum chamber 30 is defined firstly by the diffuser and more particularly by the outer first surface 24 and the outlet section 26, and secondly by an outer second surface 31. This outer second surface 31 extends the inner first surface 23 of the diffuser 20 and joins the outer first surface 24 of the diffuser 20. The plenum chamber 30 has a single radial opening 32 leading into the expansion nozzle 40.

The expansion nozzle 40 is thus connected at a first end to the radial opening 32 of the plenum chamber 30 and at its second end it has an expansion section 42 through which the gas is ejected out from the expansion nozzle 40.

The expansion nozzle 40 is constituted by a first diverging shape going from the plenum chamber 30 to the expansion section 42. Thus, the gas flowing in the expansion nozzle 40 expands prior to being ejected. A second direction F2 is defined parallel to a mean exit direction of the gas leaving the expansion nozzle 40 and is directed in the flow direction of the gas. This second direction F2 is perpendicular to the expansion section 42.

The diffuser 20 is constituted by a second diverging shape going from the annular inlet section 10 to the plenum chamber 30, this second diverging shape being defined by the inner and outer first surfaces 23 and 24. Thus, the gas flowing between the inner and outer first surfaces 23 and 24 expands prior to leaving the diffuser 20 via the outlet section 26 from the diffuser 20 into the plenum chamber 30. A third direction F3 defined perpendicularly to the outlet section 26 and directed in the flow direction of the gas lies at a second angle β equal to 180° relative to the first direction F1.

Furthermore, the exhaust nozzle 1 is preferably made out of fine sheet metal, e.g. it is made of steel or of special alloys. These fine metal sheets must be capable in particular of withstanding high temperatures when the exhaust nozzle 1 is used with a gas turbine 2, the exhaust gas from the gas turbine 2 then flowing through the exhaust nozzle 1.

Furthermore, the outer first surface 24 is terminated by a dropped edge 25 at the outlet section 26. This dropped edge 25 serves firstly to increase the stiffness of the outer first surface 24 and secondly to improve the passage of gas from the diffuser 20 to the plenum chamber 30.

In the first embodiment of the exhaust nozzle 1 as shown in FIG. 2, the second direction F2 forms a first angle α equal to 90° relative to the first direction F1. The gas is ejected from the expansion nozzle 40 perpendicularly to the direction of the first axis 3, which corresponds substantially to the direction along which gas enters into the exhaust nozzle 1 and more particularly in the diffuser 20.

The diffuser 20 and the plenum chamber 30 are then bodies of revolution around the first axis 3.

The inner first surface 23 and the outer first surface 24 are formed by respective conical surfaces of revolution, these two conical surfaces of revolution defining the second diverging shape. The inner first surface 23 and the outer first surface 24 have respective curvilinear generator lines constituted by an inner first curve and an outer first curve as can be seen in FIG. 2.

The inner first curve and the outer first curve are concave on the same side, i.e. the inner and outer first curves have their respective centers of curvature situated on the same side of these inner and outer first curves. Furthermore, the area of the gas flow section in the second diverging shape increases progressively from the annular inlet section 10 going towards the plenum chamber 30. Finally, neither the inner first curve nor the outer first curve has any point of inflection.

Consequently, the second diverging shape of the diffuser varies with a relationship serving firstly to reduce progressively the speed of the gas flowing through the diffuser 20 and secondly to delay separation of the gas boundary layer from the inner first surface 23 and from the outer first surface 24.

The plenum chamber 30 is substantially toroidal in shape. In the plane of symmetry AA of the exhaust nozzle 1, the centers C1, C2 of the circles defining this substantially toroidal shape of the plenum chamber 30 are situated on the gas ejection direction as defined by the direction F2 in the manner shown in FIG. 2. The inner first curve is thus terminated by a circular arc and the outer second surface 31 is constituted by an extension of that circular arc.

The outer second surface 31 thus does not have any line of inflection. Nevertheless, this outer second surface 31 may nevertheless include a line of inflection at its junction with the outer first surface 24 of the diffuser 20.

The plenum chamber 30 is defined in particular by a height H measured parallel to the first axis 3 and a maximum diameter _{M} measured perpendicularly to the first axis 3. The plenum chamber 30 is a body of revolution, being defined by a single diameter , which is thus the maximum diameter _{M}. The height H is much less than the diameter , this diameter being four times greater than the height H in this first embodiment. The plenum chamber 30 thus occupies relatively little volume, in particular along the direction of the first axis 3.

In the second embodiment of the exhaust nozzle 1 shown in FIGS. 3 and 4, the second direction F2 forms a first angle α equal to 135° with the first direction F1. The gas is ejected from the expansion nozzle 40 to one side of the exhaust nozzle 1 and in a direction that is opposite relative to the first direction F1 that corresponds substantially to the direction along which the gas enters into the exhaust nozzle 1.

The diffuser 20 and the plenum chamber 30 in this second embodiment are thus of shapes that are different from those of the diffuser 20 and the plenum chamber 30 of the first embodiment. The diffuser 20 and the plenum chamber 30 need to adapt to the direction along which the expansion nozzle 40 extends at the radial opening 32.

The diffuser 20 and the plenum chamber 30 extend around the first axis 3 without constituting complete bodies of revolution around the first axis 3. Nevertheless, the diffuser 20 and the plenum chamber 30 are constituted in part by bodies of revolution. The diffuser 20 and the plenum chamber 30 thus have first portions forming half a body of revolution opposite from the radial opening 32, and second portions that are not bodies of revolution, situated beside the radial opening 32.

Each first portion forming half a body of revolution of the diffuser 20 and of the plenum chamber 30 is unaffected by the direction of the expansion nozzle 40. Each first portion in the form of half a body of revolution has the first axis 3 as its axis of revolution.

In contrast, the second portion of the plenum chamber 30 and the second portion of the diffuser 20 needs to adapt to the direction of the expansion nozzle 40 in order to ensure a flow that minimizes the appearance of turbulence and head losses, in particular on passing from the plenum chamber 30 to the expansion nozzle 40 via the radial opening 32.

On the first portion forming half a body of revolution of the diffuser 20, the inner first surface 23 and the outer first surface 24 defining the second diverging shapes are formed by respective conical surfaces of revolution having as their curvilinear generator lines an inner first curve and an outer first curve as shown in FIG. 4.

In its first portion forming half a body of revolution, the plenum chamber 30 in this second embodiment does not have the shape of a torus. As in the first embodiment, the outer second surface 31 of this plenum chamber 30 extends, the inner first surface 23 in continuous manner, and it joins the outer first surface 24 of the diffuser 20.

In contrast, the zone of the plenum chamber 30 that is situated close to the annular inlet section 10 includes a flat, this flat being parallel to the annular inlet section 10. This flat serves to reduce the height H of the plenum chamber 30, thereby reducing its volume, and thus making it easier to install, e.g. on board a rotary wing aircraft.

In order to adapt to the direction of the expansion nozzle 40, the inner and outer first surfaces 23 and 24 defining the second diverging shape are modified in the second portion of the diffuser 20. Likewise, the outer second surface 31 is modified in the second portion of the plenum chamber 30 so as to be adapted to the direction of the expansion nozzle 40.

As in the first embodiment, the inner first curve and the outer first curve are concave on the same side, and neither of them has any point of inflection, whether in the first portion in the form of half a body of revolution or in the second portion. The outer second surface 31 likewise does not have any line of inflection.

Furthermore, the inner first surface 23, the outer second surface, and the outer first surface 24 all vary in continuous manner.

The area of the gas flow section for gas in this second diverging shape increases progressively from the annular inlet section 10 towards the plenum chamber 30.

The maximum diameter _{M} of the plenum chamber 30 is equal to the maximum distance between two opposite points of the outer second surface 31 or between two points of the inner first surface 23, this distance being measured perpendicularly to the first axis 3. Once more, the height H is considerably smaller than the maximum diameter _{M}, this maximum diameter _{M} being five times greater than the height H in this second embodiment.

Furthermore, the exhaust nozzle 1 includes a heat exchanger 4 and an outlet nozzle 50, the heat exchanger 4 being positioned between the expansion nozzle 40 and the outlet nozzle 50. The outlet nozzle 50 includes a bend so as to direct the gas in the desired ejection direction. Since the flow speed of the gas and also its pressure have previously been reduced in the diffuser 20, the plenum chamber 30, the expansion nozzle 40, and the heat exchanger 4, the gas is subjected to practically no additional head loss on passing through the outlet nozzle 50.

Finally, a gas turbine 2 is associated with the exhaust nozzle 1 in order to form a power plant 8. Thus, the exhaust gas leaving the gas turbine 2 flows through the exhaust nozzle 1 until it is ejected via the outlet nozzle 50. The exhaust nozzle 1 thus serves to direct the exhaust gas towards its ejection direction while limiting head losses to which the exhaust gas is subjected, thereby preserving the performance of the gas turbine 2.

Naturally, the present invention may be subjected to numerous variations as to its implementation. Although several embodiments are described, it will readily be understood that it is not conceivable to identify exhaustively all possible embodiments. It is naturally possible to envisage replacing any of the means described by equivalent means without going beyond the ambit of the present invention.

Furthermore, although the embodiments shown in FIGS. 2 to 4 describe a diffuser 20 and a plenum chamber 30 extending around a common first axis 3, it is possible for the plenum chamber 30 to extend around a second axis 6 that is different from and that intersects the first axis 3 of the diffuser 20. The second axis 6 should lie in the plane of symmetry AA of the exhaust nozzle 1. Nevertheless, the angle δ between the first axis 3 and the second axis 6 should remain limited, e.g. it should lie in the range 0° to 15°.

Furthermore, the second angle β between the first direction F1 and the third direction F3, which is equal to 180° in both embodiments shown in FIGS. 2 to 4, could in more general manner lie in the range 100° to 200°.

What is claimed is:

1. An exhaust nozzle for a gas turbine, the exhaust nozzle comprising in succession in the direction of gas flow through the exhaust nozzle:
an annular inlet section centered on a first axis, a first direction being defined parallel to the first axis and extending in the flow direction of the gas;
a diffuser;
a plenum chamber; and
a single expansion nozzle having a first end connected to the plenum chamber and having a second end with an expansion section, a first diverging shape of the expansion nozzle going from the plenum chamber to the expansion section, a second direction being defined parallel to a mean exit direction of the gas from the expansion nozzle and extending in the flow direction of the gas;
wherein:
the diffuser extends around the first axis with a second diverging shape going from the inlet section to the plenum chamber, the diffuser comprising an inner first surface and an outer first surface, the gas flowing between the inner and outer first surfaces and leaving the diffuser via an outlet section of the diffuser into the plenum chamber;
the plenum chamber is defined firstly by the diffuser and secondly by an outer second surface extending the inner first surface of the diffuser and joining the outer first surface of the diffuser, the plenum chamber having a single radial opening leading into the expansion nozzle; and
the expansion nozzle is arranged so that the second direction forms a first angle α lying in the range 60° to 180° with the first direction.

2. An exhaust nozzle according to claim 1, wherein the inner first surface and the outer first surface are concave on the same side and neither of them includes any line of inflection.

3. An exhaust nozzle according to claim 1, wherein the exhaust nozzle has a plane of symmetry containing the first axis and the mean exit direction of the gas leaving the expansion nozzle.

4. An exhaust nozzle according to claim 1, wherein the outer first surface is terminated by a dropped edge at the outlet section.

5. An exhaust nozzle according to claim 1, wherein the second diverging shape of the diffuser varies with a relationship making it possible firstly to reduce progressively the speed of the gas flowing in the diffuser and secondly to delay separation of the boundary layer of the gas from the inner first surface and from the outer first surface.

6. An exhaust nozzle according to claim 1, wherein a third direction defined perpendicularly to the outlet section and extending in the flow direction of the gas forms a second angle β lying in the range 100° to 200° with the first direction.

7. An exhaust nozzle according to claim 1, wherein a third direction defined perpendicularly to the outlet section and extending in the flow direction of the gas forms a second angle β equal to 180° with the first direction.

8. An exhaust nozzle according to claim 1, wherein the outer second surface does not include any line of inflection.

9. An exhaust nozzle according to claim 1, wherein the plenum chamber extends around a second axis forming a third angle δ lying in the range 0° to 15° relative to the first axis.

10. An exhaust nozzle according to claim 1, wherein the plenum chamber extends around a second axis that coincides with the first axis.

11. An exhaust nozzle according to claim 10, wherein when the first angle α is equal to 90°, the diffuser and the plenum chamber are respectively in the shape of bodies of revolution about the first axis.

12. An exhaust nozzle according to claim 9, wherein the plenum chamber is defined by a height parallel to the second axis and by a maximum diameter extending perpendicularly to the second axis, and the height is strictly less than the maximum diameter.

13. An exhaust nozzle according to claim 1, wherein the exhaust nozzle includes at least one heat exchanger and at least one outlet nozzle, each heat exchanger being positioned between the expansion nozzle and an outlet nozzle.

14. A power plant including at least one gas turbine and at least one exhaust nozzle, each gas turbine being connected to an exhaust nozzle via an inlet section of the exhaust nozzle, wherein the exhaust nozzle is a nozzle according to claim 1.
